(19) United States
(12) Patent Application Publication
(10) Pub. No.: US 2024/0253429 A1
(43) Pub. Date: Aug. 1, 2024

(54) VEHICLE DOOR ASSEMBLY

(71) Applicant: NISSAN NORTH AMERICA, INC., Franklin, TN (US)

(72) Inventors: Ronald B. MORROW, JR., Novi, MI (US); David KOVIE, Livonia, MI (US); James HAUPT, Livonia, MI (US)

(21) Appl. No.: 18/161,644

(22) Filed: Jan. 30, 2023

(51) Int. Cl. B60J 1/18; B60J 5/10; B60R 13/02; B60R 13/04

(52) U.S. Cl. CPC B60J 1/1861; B60J 5/101; B60R 13/0212; B60R 13/04

(57) ABSTRACT

A vehicle door assembly includes portions of a vehicle body structure that define an opening, a window and a movement mechanism. The window is movably connected to the vehicle body structure. The window is configured to move between a closed position at least partially closing the opening and an open position exposing the opening such that the window is at least partially disposed between a body member of the vehicle body structure and a trim element of the vehicle body structure. The movement mechanism has a movable member and a glass attachment structure attached to the movable member for pivotal movement with respect thereto. The movement mechanism is installed between the trim element and the body member and is configured to move the movable member and the window between the closed position and the open position.

### BACKGROUND

### Technical Field

The present disclosure generally relates to vehicle door assembly. More specifically, the present disclosure relates to vehicle door assembly that has a movement mechanism that moves an extending member having a first end fixed to a window, a second end attached to the movement mechanism with a hinge located between the window and the movement mechanism such that the first end of the extending member can pivot relative the second end as the orientation of the window changes during movement of the window between an open position and a closed position.

### Background Information

Vehicles with rear openings typically have a rear door that pivots upward and rearward from the rear opening about hinge structures. Since the rear door pivots upward, the overall height of the vehicle increases when the rear door is in an open position.

### SUMMARY

One object of the present disclosure is to provide a door at the rear of a vehicle that moves into a space between a roof panel and a headliner within the vehicle via a movement mechanism that is located within the space between the roof panel and the headliner.

Another object of the present disclosure is to provide a window with a movement mechanism with pivoting structures connected to the window such that a first movement path of the window and a second movement path of the movement mechanism differ with the pivoting structures compensating for the difference between the two movement paths.

In view of the state of the known technology, one aspect of the present disclosure is to provide a vehicle door assembly includes portions of a vehicle body structure that define an opening, a window and a movement mechanism. The window is movably connected to the vehicle body structure. The window is configured to move between a closed position at least partially closing the opening and an open position exposing the opening such that the window is at least partially disposed between a body member of the vehicle body structure and a trim element of the vehicle body structure. The movement mechanism has a movable member and a glass attachment structure attached to the movable member for pivotal movement with respect thereto. The movement mechanism is installed between the trim element and the body member and is configured to move the movable member and the window between the closed position and the open position.

### BRIEF DESCRIPTION OF THE DRAWINGS

Referring now to the attached drawings which form a part of this original disclosure:

FIG. 1 is a perspective view of a vehicle having a rear door opening and a vehicle door assembly in which a window and lower door are in closed positions in accordance with a first embodiment;

FIG. 2 is another perspective view of the vehicle similar to FIG. 1 in which the window and lower door are both in respective open positions in accordance with the first embodiment;

FIG. 3 is a perspective schematic view of the rear of the vehicle showing guide assemblies with channels that support and guide the window and the lower door as they are moved between their respective open and closed positions and showing the window and door in their respective closed position in accordance with the first embodiment;

FIG. 4 is another perspective schematic view of the rear of the vehicle showing guide assemblies with the channels that support and guide the window and the door as they are moved between their respective open and closed positions and showing the window its open position and the door in its closed position in accordance with the first embodiment;

FIG. 5 is a schematic side view of the rear of the vehicle showing the guide assemblies with channels that support and guide the window as it is moved between its open and closed positions by a movement mechanism, with the window and the door being shown in their respective closed positions in accordance with the first embodiment;

FIG. 6 is another schematic side view of the rear of the vehicle similar to FIG. 6 showing the guide assemblies with channels that support and guide the window as it is moved between its open and closed positions by a movement mechanism, with the window and the door being shown in their respective open positions in accordance with the first embodiment;

FIG. 7 is a perspective view of movement mechanism and the window in the closed position removed from the vehicle showing the movement mechanism attached to the upper end of the window, and further showing a track, a movable member and a motor of the movement mechanism in accordance with the first embodiment;

FIG. 8 is another perspective view similar to FIG. 7 showing the window in the open position with the movable member of the movement mechanism attached to the upper end of the window, and further showing the track, and the motor of the movement mechanism in accordance with the first embodiment;

FIG. 9 is a perspective view of a portion of the movable member and a portion the track removed from the vehicle showing one of a pair of wings that extends laterally from the movable member, a hinge, a rearward member and a glass attachment structure with the hinge pivotally connecting the rearward member to a respective one of the wings with the glass attachment member being fixed to the rearward member such that the glass attachment member and the rearward member pivot about the hinge in accordance with the first embodiment;

FIG. 10 is another perspective view of the movable member and the portion the track removed from the vehicle showing the pair of wings that extend laterally from the movable member, one of the hinges, one of the rearward members and one of the glass attachment structures attached to the window in accordance with the first embodiment;

FIG. 11 is another perspective view of the movement mechanism with the motor removed showing the movable member moved on the track in solid lines to a location along the track corresponding to the window being in the closed position and showing the movable member moved on the track in phantom lines to a location along the track corresponding to the window being in the open position with the movable member being free to move under the roof bow in accordance with the first embodiment;

FIG. 12 is a perspective view of the roof bow, a rearward beam of the roof that supports a rearward end of the track showing the movable member positioned beneath the rearward beam, the movable member positioned on the track at the location corresponding to the window being in the closed position with the movable member being free to move under the beam in accordance with the first embodiment;

FIG. 13 is a top view of the movement mechanism removed from the vehicle showing the motor, the track, the movable member, a belt and a pulley positioned by the motor to move the movable member along the track, and showing the movable member with wings, hinge, rearward members and glass attachment structures in accordance with the first embodiment;

FIG. 14 is a bottom perspective view of the roof panel looking rearward within the vehicle with the movement mechanism being supported under the roof panel by a forward beam or bracket and a rearward roof bow beam showing the movable member in the position corresponding to the window being in the closed position in accordance with the first embodiment;

FIG. 15 is a bottom perspective view of a portion of the roof panel and a forward portion of the movement mechanism being supported under the roof panel by the forward beam or bracket and showing the window moved to the open position by the movable member and the motor in accordance with the first embodiment;

FIG. 16 is a side view of the track, the movable member and the motor of the movement mechanism, the forward beam, the roof bow and the rearward beam with the window in the closed position with the roof panel removed in accordance with the first embodiment;

FIG. 17 is another side view of the track, the movable member and the motor of the movement mechanism, the forward beam, the roof bow and the rearward beam with the window in the open position with the roof panel removed in accordance with the first embodiment;

FIG. 18 is a perspective view of a portion of the movable member and a portion the track removed from the vehicle showing a one of a pair of wings that extends laterally from the movable member, a first hinge, a rearward member, a second hinge and a glass attachment structure with the first hinge pivotally connecting the rearward member to a respective one of the wings and the second hinge pivotally connecting the rearward member with the glass attachment member such that the glass attachment member and the rearward member pivot about the first hinge and the second hinge in accordance with a second embodiment;

FIG. 19 is an exploded view of a vehicle door showing an outer door panel, a movement mechanism and an inner door panel in accordance with a third embodiment;

FIG. 20 is a side view of the movement mechanism removed from the door in accordance with the third embodiment;

FIG. 21 a cross-sectional view of the door depicted in FIGS. 19 and 20 showing the movement mechanism having moved the window to the closed position in accordance the third embodiment; and

FIG. 22 another cross-sectional view of the door similar to FIG. 21 showing the movement mechanism having moved the window to the open position in accordance the third embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

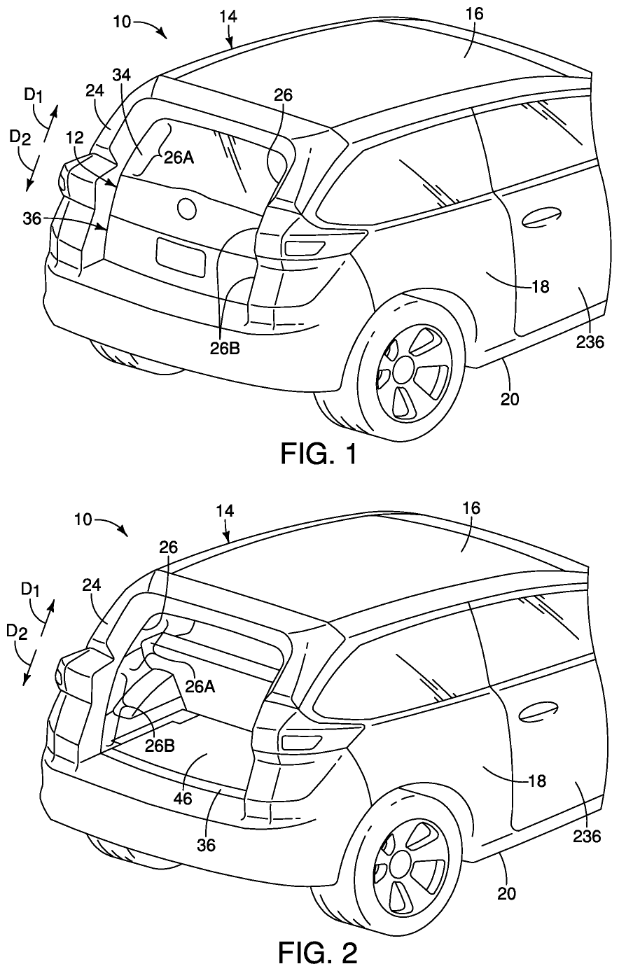

Referring initially to FIG. 1-4, a vehicle 10 having a vehicle door assembly 12 is illustrated in accordance with an exemplary embodiment. The vehicle door assembly 12 is hereinafter referred to as the door assembly 12.

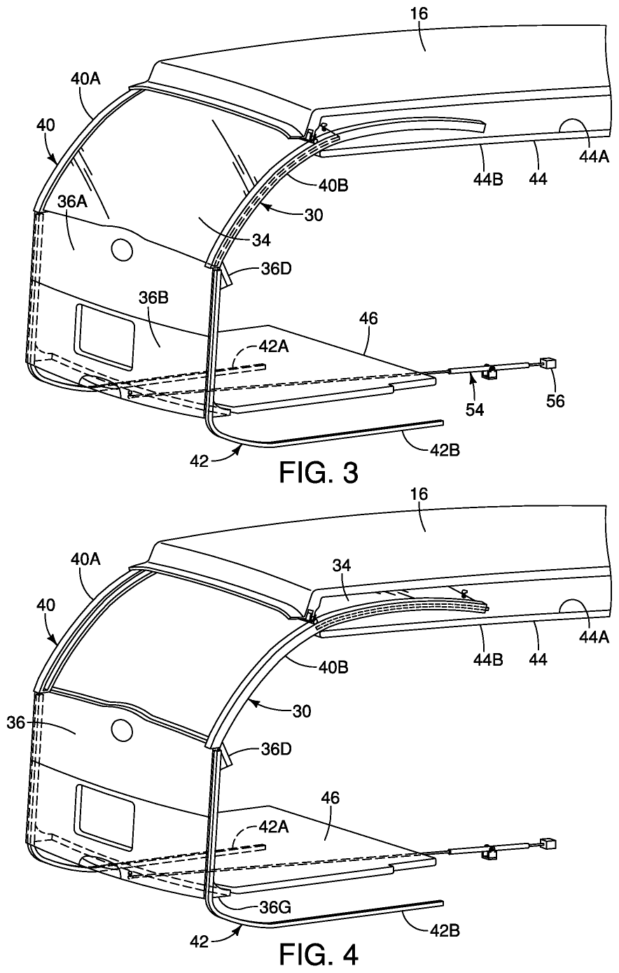

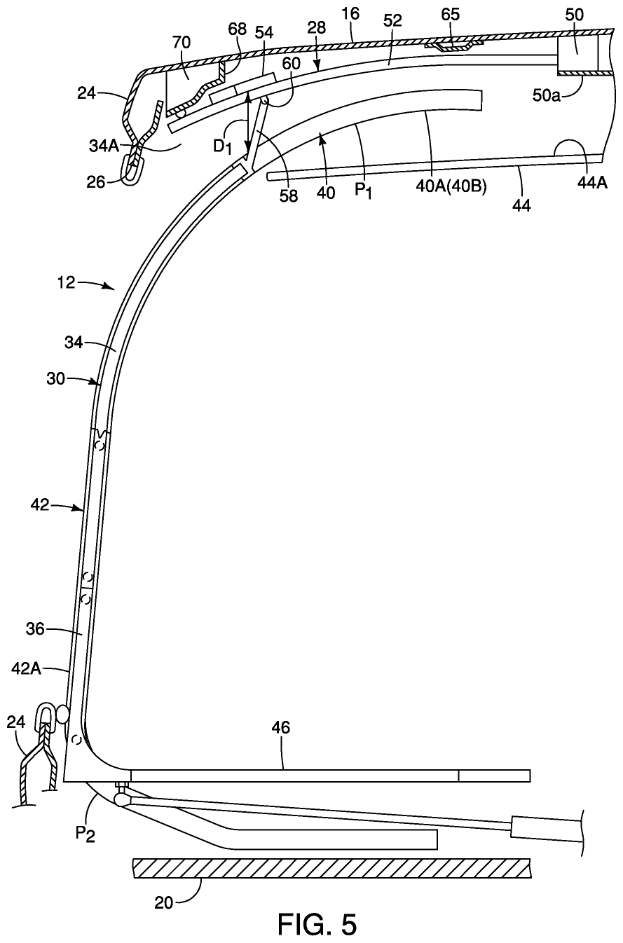

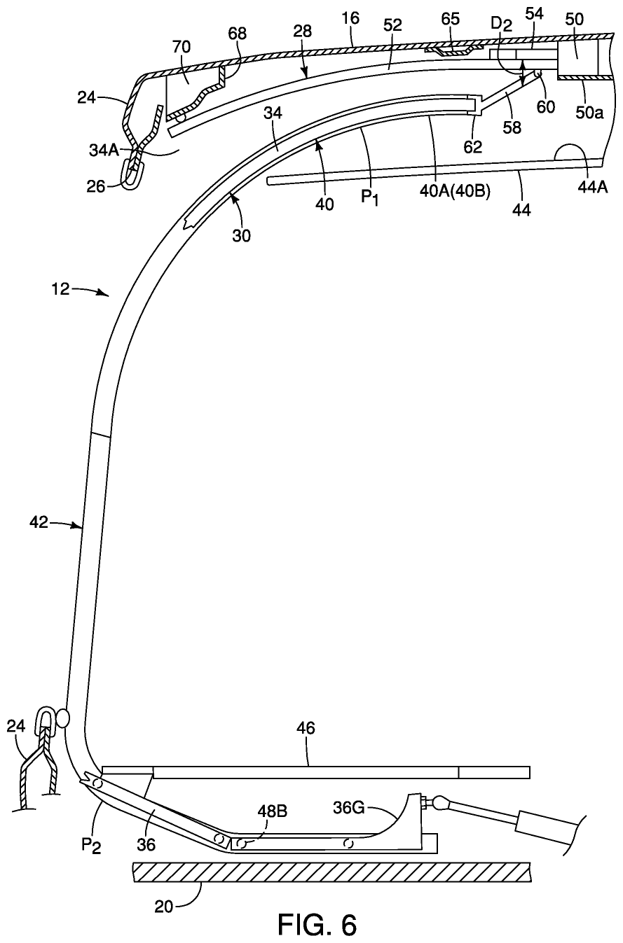

The vehicle 10 has a vehicle body structure 14 that includes at least a roof panel 16, side panels 18, a floor panel 20 defining a cargo/passenger compartment 22 and a rear wall structure 24. The rear wall structure 24 of the body structure 14 defines a door opening 26 that provides access to the cargo/passenger compartment 22. As shown in FIGS. 5 and 6, the door assembly 12 includes a movement mechanism 28 that is described further below. As shown in FIGS. 3-6, the vehicle body structure 14 further includes a support assembly 30 (also referred to as guides 30 and tracks 30.

The vehicle body structure 14 also includes various additional conventional structures, components and elements that are well known in the art. Since these structures, components and elements are well known in the art, further description is omitted for the sake of brevity.

The door assembly 12 includes a window 34 and a door 36 movably connected to the vehicle body structure 14. The window 34 and the door 36 are movable between respective closed positions covering an upper section 26A and a lower section 26B of the door opening 26, as shown in FIGS. 1, 3 and 5, and respective open positions exposing the corresponding upper and lower sections 26A and 26B of the door opening 26, as shown in FIGS. 2 and 6. The window 34 covers the upper section 26A of the door opening 26 when the window 34 is in the closed position, as shown in FIGS. 1 and 3. The door 36 covers the lower section 26B of the door opening 26 when the door 36 is in the closed position, as shown in FIGS. 1 and 3. When the window 34 and the door 36 are in the open positions, the window 34 is separated from and has a non-contacting relationship with the door 36, as shown in FIG. 2. The upper and lower sections 26A and 26B of the door opening 26 are uncovered when the window 34 and the door 36 are in the open position, as shown in FIGS. 2 and 6. The window 34 is configured to move in a first direction D₁ from the closed position to the open position. The door 36 is configured to move in a second direction D₂ from the closed position to the open position. The second direction D₂ is a different direction from the first direction D₁. A lower end of the window 34 contacts an upper end of the door 36 when the window 34 and door 36 are in their respective closed positions, as shown in FIGS. 1, 3 and 5. The door 36 has a door movement mechanism that is separate from the movement mechanism 28. The door movement mechanism can be any of a variety of convention movement mechanisms and therefore description thereof is omitted for the sake of brevity.

The window 34 is preferably made entirely of a transparent material, such as, for example, a laminated automotive glass. Alternatively, the window 34 can include a metallic frame that surrounds and supports the laminated automotive glass. The door 36 can be made of a non-transparent material, such as a plastic molded wafer panel and can also be made of or partially made of a transparent material. The door 36 can include portions of a panel or an entire panel made of a transparent material, such as a laminated automotive glass. Alternatively, the door 36 can be made of any suitable material, such as steel, aluminum, magnesium, glass or other suitable material.

The support assembly 30 includes a first guide assembly 40 and a second guide assembly 42, as shown in FIGS. 3-6. The first guide assembly 40 includes first and second run channels 40A and 40B configured to movably receive the window 34. The second guide assembly 42 includes first and second rails 42A and 42B configured to movably receive the door 36.

As shown in FIGS. 5 and 6, the first and second run channels 40A and 40B of the first guide assembly 40 define a first travel path P₁ for the window 34. The window 34 travels along the first travel path P₁ between the closed and open positions. The first travel path P₁ has a substantially arcuate shape and is therefore curved and preferably is curved consistently about an unmarked center such that the radius of the first travel path P₁ is measured in feet, such as 20 to 40 feet or any value therebetween. The window 34 is similarly curved and can basically a section of a surface of a sphere or a section of a surface of an ellipsoid with curvature as viewed from either side thereof and another curvature (or the same curvature as viewed from the sides thereof) as viewed from an upper edge or a lower edge thereof.

The first and second rails 42A and 42B of the second guide assembly 42 define a lower travel path for the door 36. The door 36 travels along the lower travel path between the closed and open positions. The shape of the lower travel path can be different from the shape of the first travel path P₁. The first and second rails 42A and 42B are preferably substantially C-shaped members. A further description of the door 36, related devices and structures is provided in co-pending U.S. patent application Ser. No. 17/738,881, Filed May 6, 2022 and incorporated herein by reference in its entirety.

The first and second run channels 40A and 40B of the first guide assembly and the first and second rails 42A and 42B of the second guide assembly 42 are preferably fixed to interior surfaces of the rear wall structure 24 adjacent to respective opposite lateral sides of the door opening 26. More specifically, the first run channel 40A and the first rail 42A are attached to the rear wall structure 24 along a driver's side of the door opening 26, and the second run channel 40B and the second rail 42B are attached to the rear wall structure 24 along a passenger's side of the door opening 26. Portions of the first and second guide assemblies 40 and 42 proximate the open positions of the window 34 and the door 36 are secured to the roof panel 16 and floor panel 20, respectively, in any suitable manner, such as with brackets and mechanical fasteners or welding techniques.

The first and second run channels 40A and 40B are substantially identical to one another except that they are symmetrical mirror images of one another. The first and second run channels 40A and 40B of the first guide assembly 40 are dimensioned and positioned to support and direct movement of the window 34 between the closed position (FIGS. 1, 3 and 5) and the open position (FIGS. 2, 4 and 6), and any position therebetween. As shown in FIGS. 4 and 6, the window 34 is positioned between a headliner 44 and the roof panel 16 when in the open position. The headliner 44 (also referred to as a trim element) is installed to the side structures 18 and the roof panel 16 in a conventional manner with a gap defined between the roof structure 16 and the headliner 44 at a location adjacent to the rear wall structure 24. In other words, the window 34 is configured to be received between the headliner 44 and the roof panel 16 of the vehicle body structure 14 when the window 34 is in the open position. The headliner 44 is a conventional vehicle component, such that further description of the headliner 44 is omitted for the sake of brevity.

The first and second rails 42A and 42B are substantially identical to one another except that they are symmetrical mirror images of one another. The first and second rails 42A and 42B of the second guide assembly 42 are dimensioned and positioned to support and direct movement of the door 36 between the closed position (FIGS. 1, 3 and 5) and the open position (FIGS. 2 and 6), and any position therebetween. As shown in FIGS. 4 and 6, the door 36 is positioned between a cargo floor, or floor liner 46 and the floor panel 20 in the open position. The cargo floor 46 is installed to the side structures 18 and the floor panel 20 in a conventional manner with a gap defined between the floor panel 20 and the cargo floor 46 at a location adjacent to the rear wall structure 24, as shown in FIG. 6. In other words, the door 36 is configured to be received between the cargo floor 46 and the floor panel 20 of the vehicle 10 when the door 36 is in the open position. The cargo floor 46 is a conventional vehicle component, such that further description of the cargo floor 46 is omitted for the sake of brevity.

The window 34 is preferably directly received by the first and second run channels 40A and 40B, as shown in FIG. 4. A plurality of door support members 48 movably connect the door 36 to the first and second rails 42A and 42B, as shown in FIG. 8.

The first and second run channels 40A and 40B are preferably made of or lined with a friction free material, such as, for example, polytetrafluoroethylene (PTFE) Alternatively, each of the first and second run channels 40A and 40B can be disposed within a track such that each of the first and second run channels 40A and 40B is retained within the track and allows for movement of the window 34 through the first and second run channels 40A and 40B. The first run channel 40A is disposed on a driver's side of the window 34. The second run channel 40B is disposed on the passenger's side of the window 34. The first and second run channels 40A and 40B are substantially similarly configured.

The window 34 is connected to a movement mechanism 28 and is moved between the closed and open positions by the movement mechanism 28, as shown in FIGS. 1-6. The movement mechanism 28 installed between the headliner 44 (trim element) and the roof panel 16 (a body member) dimensioned and configured to move the window between the closed position and the open position.

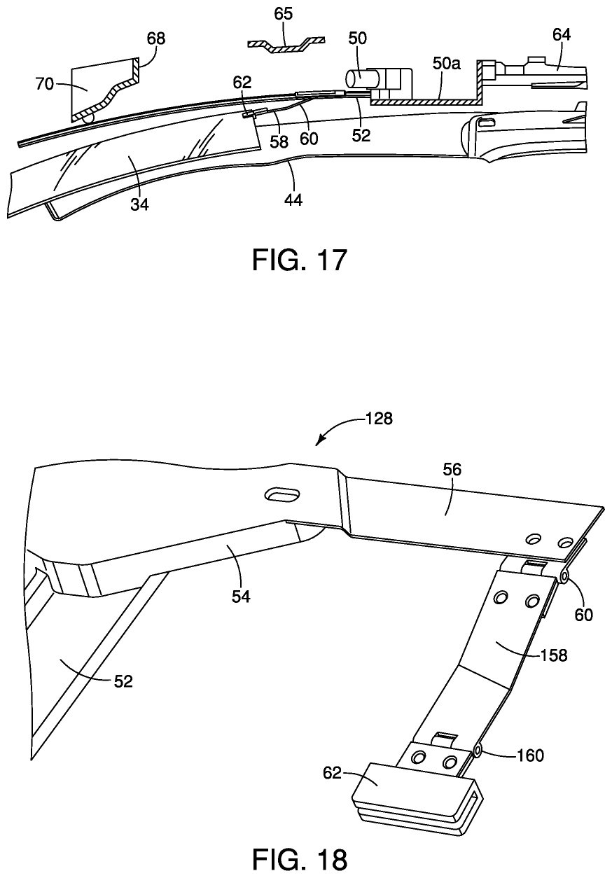

A description of the movement mechanism 28 is now provided with reference to FIGS. 5-17. The movement mechanism 28 includes a motor 50, a rail or track 52, a movable member 54, a pair of wings 56, rearward members 58, hinges 60 and glass attachment structures 62. The movement mechanism 28 is supported to the roof panel 16 via brackets 64 and 68. The brackets 64 and 68 are, for example, roof bows and/or reinforced beams that are attached to the roof panel 16 via fasteners or welding techniques providing support and stiffness to the roof panel 16. As shown in FIGS. 5, 6, 12, 16 and 17, a vertically oriented bracket 70 is fixed to an upper surface of the roof bow 68 (bracket 68) and a lower surface of the roof panel 16 providing stiffness and additional strength. An additional roof bow 65 is fixed to the roof panel 16 between the brackets 64 and 68 and is spaced apart from the movement mechanism 28 such that the movable member 54 can move beneath the roof bow 65 with clearance such that there is no interference between the movable member 54 and the roof bow 65.

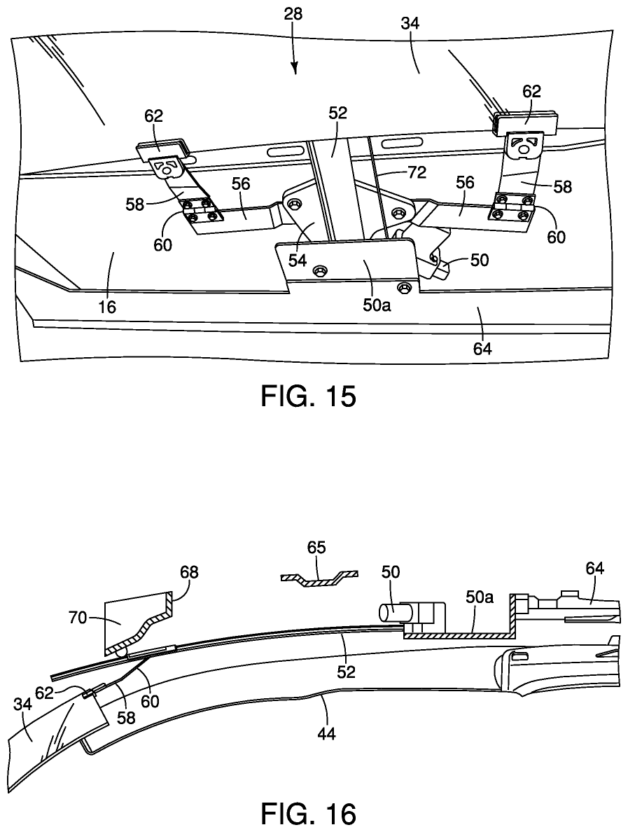

The motor 50 is supported to the bracket 64 (roof bow) via a bracket 50a that is fixed to or integrally part of the bracket 64 and extends under the motor 50. The motor 50 is fixed to the bracket 50a via, for example, mechanical fasteners F₁, as shown in FIGS. 14 and 15.

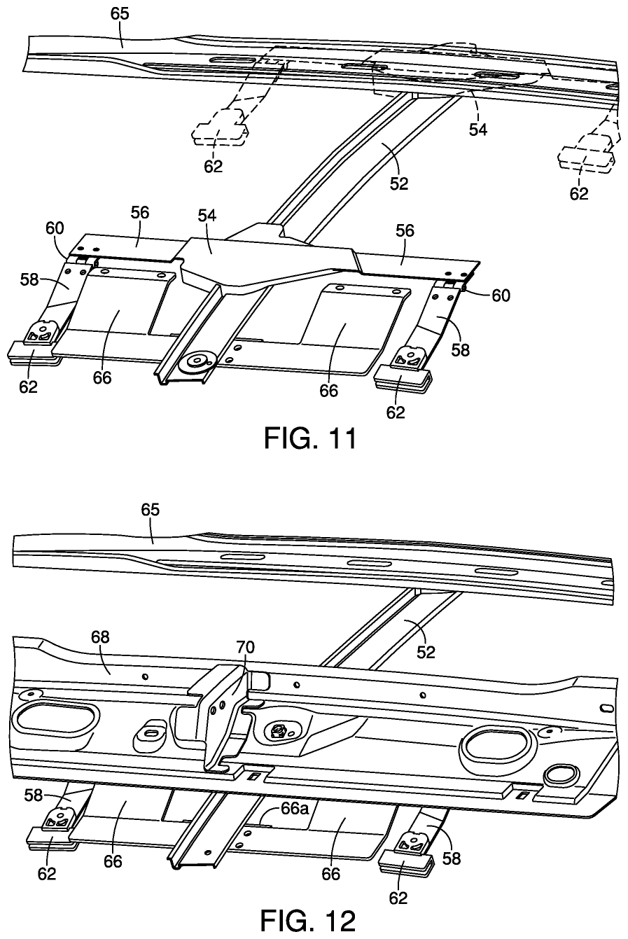

The rail or track 52 extends rearward from the motor 50 and is positioned between the channels 40A and 40B of the first guide assembly 40. The track 52 is preferably centered between the channels 40A and 40B (also referred to as the opposing rails 40A and 40B) but alternatively can be positioned off center between the channels 40A and 40B. The forward end of the track 52 is fixed to one or both of the bracket 64 and the motor 50. As shown in FIGS. 11-14, a rearward end of the track 52 includes extension brackets 66a that attached to respective ones of brackets 66. As shown in FIGS. 10-12, each of the bracket 66 has an L-shape with a first portion 66b being fixed to the corresponding one of the extension brackets 66a. The first portions 66b extend laterally away from the track 52. Each bracket 66 further includes an offset bracket portion 66c that is bent to extend upward from the first portion 66b. An end portion 66d of the offset bracket portion 66c is located above the track 52 and the movable member 54. The end portions 66d attach to the rearward beam 68 at locations spaced apart from and above the track 52 such that there is sufficient clearance for the movable member 54 to move below the beam 68 along the track 52, as shown in FIG. 16.

The track 52 is preferably made of a metallic material coated with a friction free material such that the movable member 54 can slide freely along the track 52. Alternatively, the track 52 can be made of a plastic or polymer material in its entirety that has low friction characteristic or be friction free with respect to the movable member 54. The track 52 defines a second path P₂ as shown in FIGS. 5 and 6. The moveable member 54 travels along the second travel path P₂ between the closed and open positions. The second travel path being at least partially parallel to portions of the roof panel 16. The shape of the second travel path P₂ is different from the shape of the first travel path P₁.

As shown in FIG. 10, the movable member 54 can include a lateral movement restriction recess 54a and corresponding projection (not shown). A projection 52a of the track 52 extends into the recess 54a in order to ensure linear movement of the movable member 54 along the track 52. The projection 52a can optionally include a channel or recess (not shown) dimensioned to receive an optional projection (not shown) within the recess 54a of the moveable member 54 ensuring that vertical movement of the movable member 54 relative to the track 52 is restricted and/or prevented. Hence, the moveable member 54 can only move in a lengthwise direction along the track 52.

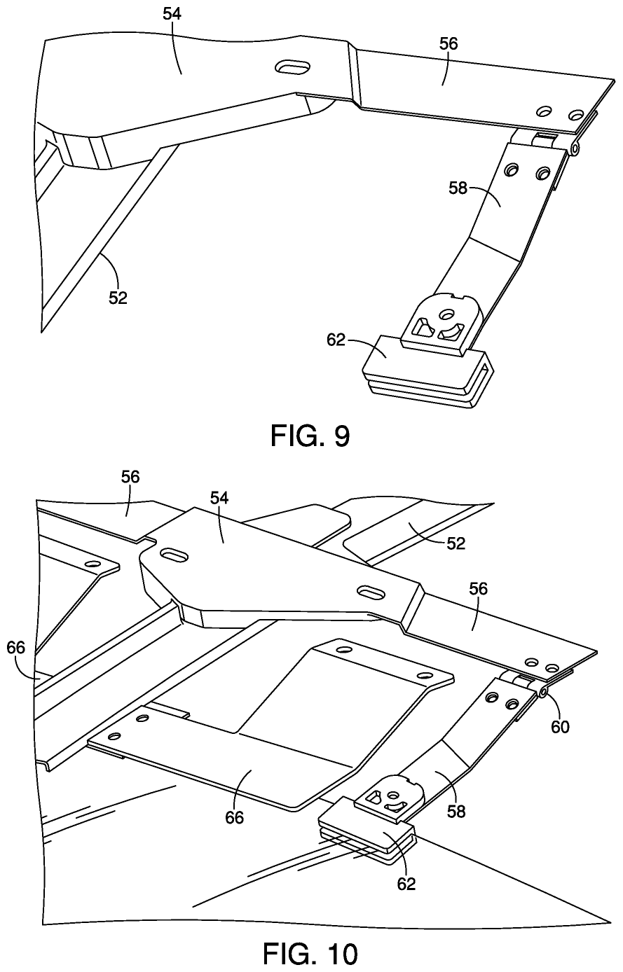

As shown in FIGS. 9-11 and 13-17, the movable member 54 includes the pair of wings 56, the wings 56 being fixedly attached to or manufactured with the movable member 54. The wings 56 extends laterally from opposite sides of the movable member 54 (one wing 56 per lateral side of the movable member 54). As shown in FIG. 10, the wings 56 extend laterally beyond the brackets 66. Each of the wings 56 includes one of the rearward members 58. The rearward members 58 are fixed to a corresponding one of the wings 56 via a corresponding one of the hinges 60. Hence, each rearward member 58 pivots relative to its wing 56 via the corresponding one of the hinges 60. Each of the rearward member 58 can further include a bend 58a that is not perpendicular to the length of the rearward member 58 but is angularly offset from the length of the rearward member 58 to accommodate the curvature of the window 34.

The glass attachment structures 62 (also referred to as claw member 62) are fixedly attached to distal ends of corresponding ones of the rearward members 58. The glass attachment structures 62 are fixedly attached to an upper edge of the window 34. Each of the glass attachment structures 62 can be fixed to the window 34 via any of a variety of means. For example, the glass attachment structures 62 can be clamps that mechanically clamp to the glass of the window 34. Alternatively, an adhesive material can be used with or without the clamping to attach the window 34 to the glass attachment structures 62. Further, the glass of the window 34 can include an opening that receives a cushioned fastener that extends through the opening in the glass and through corresponding openings in the glass attachment structures 62.

The window 34, in particular if made entirely of glass, has a compound arcuate shape having an arcuate shape discernable along sides thereof and along a rear and forward edges thereof. Basically, the window 34 can have a curved shape that corresponds to a portion of an outer surface of a large sphere or ellipse, where the sphere or ellipsoid has a radius measured in yards or meters from its center(s). In other words, the curvature of the glass of the window 34 is perceptible but is very slight.

As can be discerned in FIGS. 5 and 6, the track 52 has a curvature with a radius that is greater than the curvature of the glass of the window 34, or alternatively the track 52 can be substantially straight, or can have straight portions and curved portions. Hence, movement of the movable member 54 along the track 52 is not parallel to movement of the window 34 throughout their respective movement paths. Hence, as mentioned above, the rearward member 58 pivots about the hinges 60 in order to account for the differences in the movement of the movable member 54 as it moves the window 34. In other words, as the window 34 moves along the path P₁, an angle defined between the window 34 and the movable member 54 changes. The hinges 60 compensate for this change in angle.

The second travel path P₂ diverges from the first travel path P₁. Put another way, the shape and positioning of the second travel path P₂ differs from the shape and positioning of the first travel path P₁ such that with the window 34 in the closed position the movable member 54 is a first distance D₁ away from an adjacent portion of the first travel path P₁, as shown in FIG. 5. With the window 34 in the open position the movable member 54 is a second distance D₂ away from an adjacent portion of the first travel path P₁, the first distance D₁ being different from the second distance D₂.

Since the window 34 has a curved shape, the glass attachment structures 62 at the end of the two corresponding rearward members 58 are preferably not parallel to one another due to this curvature. The bend 58a in each of the rearward member 58 is provided to correspond to the curvature of the window 34.

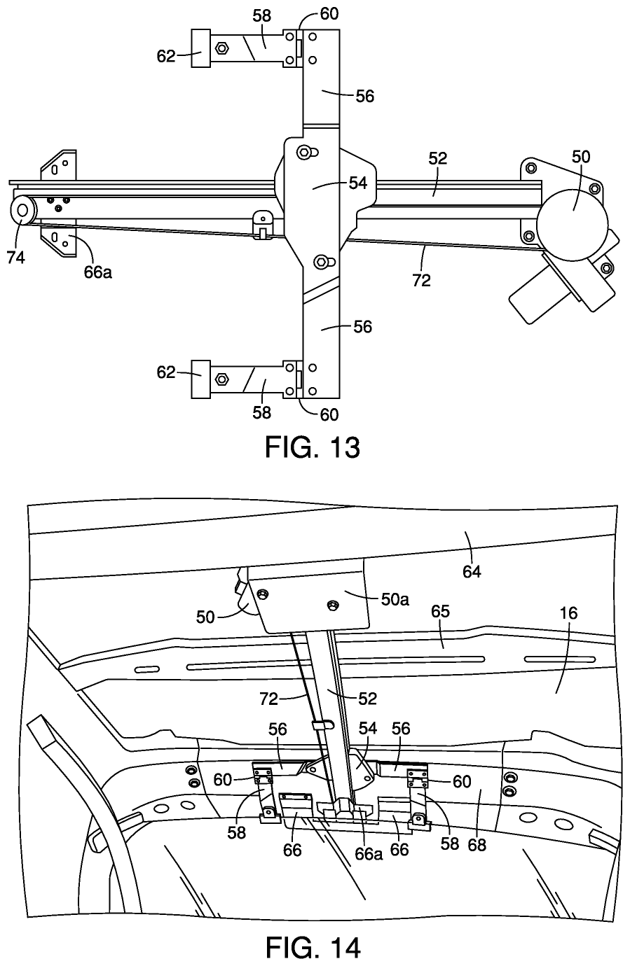

As shown schematically in FIGS. 13 and 14, the motor 50 transfers rotary motion to movement of the window 34 via a cable, chain or belt 72 that loops around a pulley (not shown that is part of the motor 50) to a pulley 74 at a rearward end of the track 52. The belt 72 is further connected to the movable member 54 such that operation of the motor 50 selectively moves the belt 72 and the movable member 54 back and forth along the track 52 to various positions between the closed orientation and the open orientation. Hence, via operation of the motor 50, specific positioning of the window 34 can be precisely accomplished. The motor 50 is preferably a stepper motor designed and constructed for precise positioning of the window 34 via the belt 72.

The motor 50 can include internal sensors that detect tension on the belt 72 indicating that the window 34 has been moved to the closed position or to the open position. A corresponding signal sent to the controller 76 causes the controller 76 to cease operation of the motor 50 and lock the motor 50 to prevent further rotation of the motor 50 thereby maintaining the window 54 in the close position and the open position. Alternatively, the track 52 can be provided with sensors (not shown) indicating that the window 34 is in the closed position or the open position.

It should be understood from the drawings and the description herein that the controller 76, via mechanical switches (not shown) can move the window 34 to any of a variety of positions between the open position and the closed position.

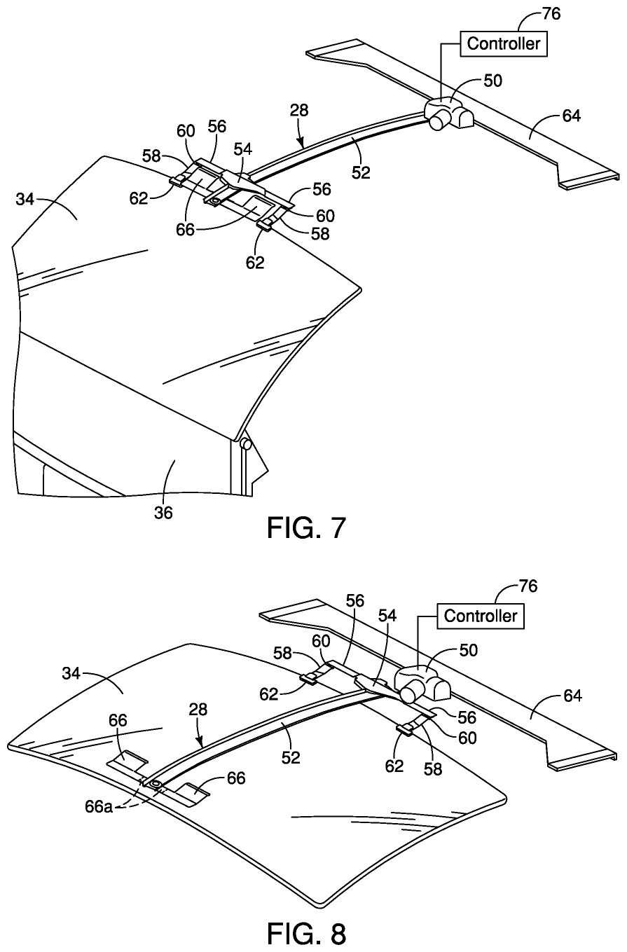

As shown schematically in FIGS. 7 and 8, the motor 50 is electronically connected to a controller 76. The controller 76 preferably includes a microcomputer with a door operating control program that controls the upper and lower doors 34 and 36. The controller 76 can also include other conventional components such as an input interface circuit, an output interface circuit, and storage devices such as a ROM (Read Only Memory) device and a RAM (Random Access Memory) device. The microcomputer of the controller 76 is programmed to control the motor 50 and a motor that controls movement of the door 36. The controller 76 is operatively coupled to a switch or switches that are manually operated to move the upper and lower doors 34 and 36 to positions between the open and closed positions in a conventional manner.

Among other things, the controller 76 is configured to independently move the window 34 and the door 36 between their respective open and closed positions. More specifically, the window 34 can be moved between its open and closed positions without moving the door 36. Similarly, the door 36 can be moved between its open and closed positions without moving the window 34.

Since the window 16 always remains below or lower than the roof panel 16, an overall height of the vehicle 10 is not increased when the window 34 is in its open position.

### Second Embodiment

Referring now to FIG. 18, a movement mechanism 128 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The movement mechanism 128 includes many elements of the movement mechanism 28 of the first embodiment. For example, the movement mechanism 128 includes the motor 50 (not shown in FIG. 18), the track 52, the movable member 54, the wings 56, the hinge 60 and the glass attachment structures 62 (aka claw members 62). However, in the second embodiment, the rearward members 58 are replaced with rearward members 158. Respective forward ends of the rearward members 158 are attached to respective ones of the hinges 60 and rearward ends of the rearward members 158 are attached to respective second hinges 160 that in turn attach to the glass attachment structures 162. Consequently, the glass attachment structures 162 are free to pivot about the second hinges 160 and the rearward members 158 are free to pivot about the hinges 60. The inclusion of both the hinges 60 and the second hinges 160 allow for greater freedom of movement of the glass attachment structures 162 as the rear door 34 (not shown in FIG. 18) moves between its open and closed positions.

### Third Embodiment

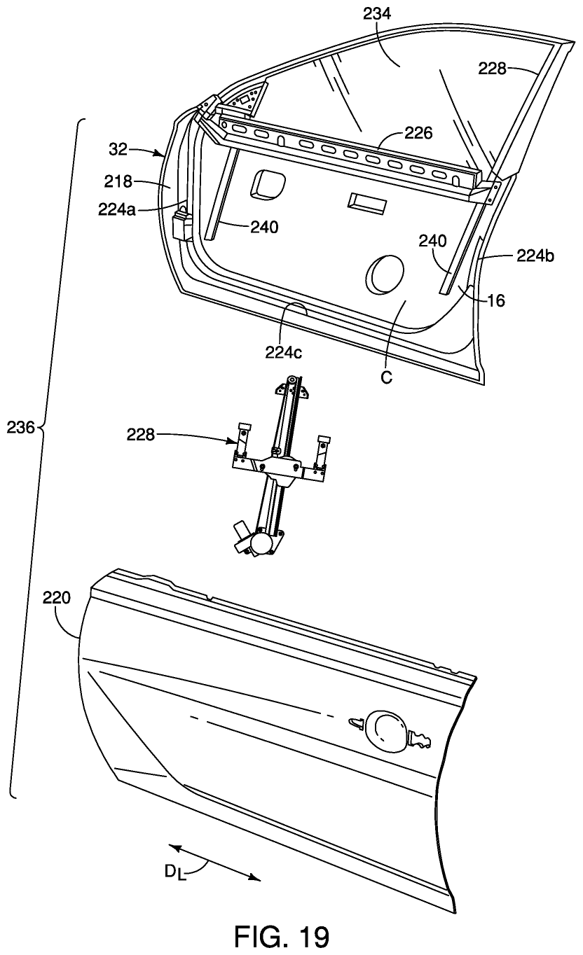

Referring now to FIG. 19-22, a movement mechanism 228 and a vehicle side door 236 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

As shown in FIGS. 1 and 2, the vehicle side door 236 (hereinafter the side door 236) is pivotally supported to a pillar structure (not shown) of the vehicle body structure 12 in a conventional manner. In the third embodiment, the side panel 18 (FIGS. 1 and 2) defines side door opening such that the side door 236 pivots between an open position and a closed position exposing and covering the side door opening in a conventional manner.

As shown in FIGS. 19, the side door 236 includes, among other elements, an inner door panel 218, an outer door panel 220, a movement mechanism 228 and a window 234. In FIG. 19, various features such as a door latch mechanism, door handle mechanism and reinforcement beams have been removed for the sake of clarity.

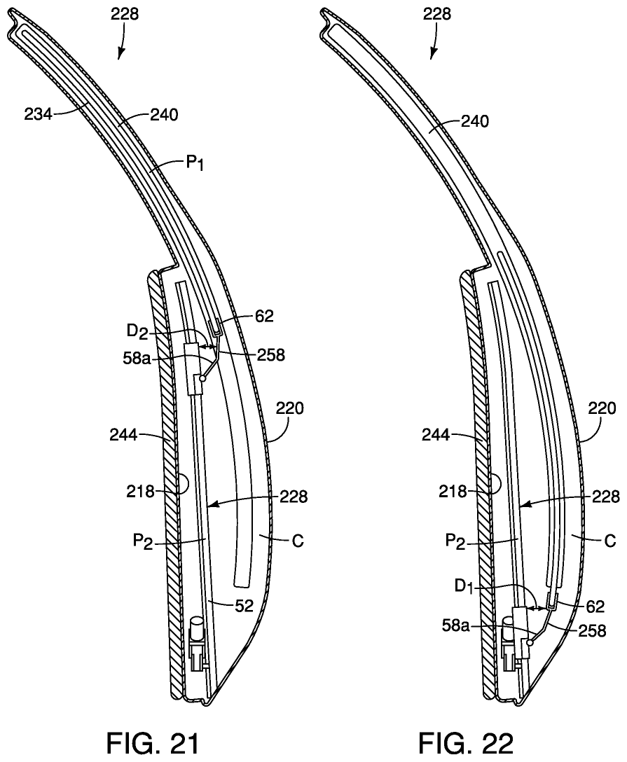

The inner door panel 218 includes a forward wall 224a, a rearward wall 224b, a bottom wall 224c, a window slot 226, a window opening 228 and window guide members 240. The guide members 240 are part of an upper portion of the inner door panel 218 and extending along opposite sides of the window opening 228. As shown in FIGS. 21 and 22, an inboard surface of the inner door panel 218 includes a trim element or door trim panel 244. The door trim panel 244 (trim element) is attached to the inner door panel 218 in a conventional manner.

As shown in FIGS. 21 and 22, the outer door panel 220 is fixed the inner door panel 218 in a conventional manner, such as welding techniques, defining a door cavity C therebetween.

The movement mechanism 228 is installed within the door cavity C between the inner door panel 218 and the outer door panel 220. Upper and lower ends of the movement mechanism 228 are preferably attached to the inner door panel 218 via brackets or beams that fastened or welded to the inner door panel 218.

The movement mechanism 228 includes many elements and assemblies that are the same as in the movement mechanism 228 of the first embodiment. Specifically, the movement mechanism 228 includes the motor 50, the rail or track 52 and the movable member 54. The motor 50, track 52 and the moveable member 54 are as described above in the first embodiment.

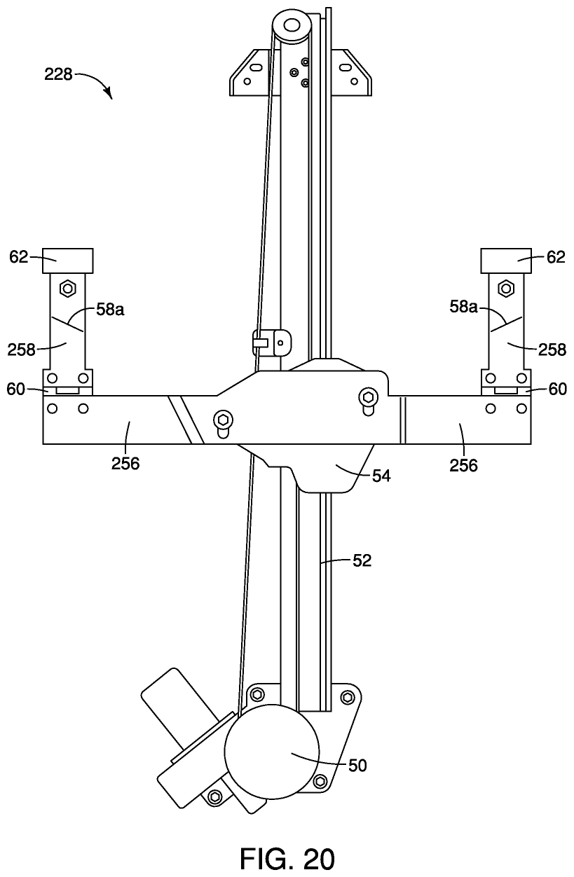

The movement mechanism 228 includes wings 256, members 258 and glass attachment structure 62. The wings 256 can be two separate members or can be a single member that attached directly to the movable member 54, as shown in FIG. 20. The combined lengths of the wings 256 or length of the single wing 256 is determined based on the width of the window 234. Specifically, the single wing 256 is preferably a value between 30% to 60% of the overall horizontal width of the window 234. The wing 256 is perpendicular to the track 52 and moved up and down with the movable member 54.

The members 258 are attached to opposite ends of the wing 256 via hinges 60. More specifically, the hinges 60 are fixed to the wing 256 and to respective ones of the members 258 such that the members 258 pivot about the hinge 60 and pivot relative to the wing 256. Each of the members 258 can optionally include a bend 58a that is angularly offset from the lengthwise direction of the member 258 and is neither perpendicular nor parallel to the track 52 or the wing 256. The bend 58a is optional and is only included if the window 234 is curved as viewed from top and bottom of the window 234. The bend 58a provides an angular offset between the two glass attachment structures 62 in the event that there is curvature in the window 34.

As shown in FIGS. 21 and 22, the track 52 (as well as the movement mechanism 228) is fixed to the inner door panel 218. The door trim panel 244 is fixed to the inboard surface of the inner door panel 218. Hence, the movement mechanism 228 is installed within the door 236 between the outer door panel 220 (a body member) and the trim panel 244 (a trim member).

The window guide members 240 located at opposite sides of the window opening 228 are shaped and dimension such that the curved window 234 travels along the guide members 240 between the closed and open positions shown in FIGS. 21 and 22, respectively. The guide members 240 define a first travel path P₁ that has a substantially curved shape corresponding to the curved shape of the window 234.

The track member 52 can have a curved contour. However, in the depicted third embodiment as shown in FIGS. 21 and 22, the track member 52 is substantially straight with a upper portion having a slight curvatures. The track member 52 defines a second travel path P₂ such that the movable member 54 moves along the second travel path P₂ between the closed position and the open position of the window 234.

The overall shape of the second travel path P₂ is different from the shape of the first travel path P₁ such that with the window 234 in the open position the movable member 54 is a first distance D₁ away from an adjacent portion of the first travel path P₁. With the window 234 in the closed position the movable member is a second distance D₂ away from an adjacent portion of the first travel path P₁, the first distance P₁ being different from the second distance P₂.

The various structures and devices of the vehicle 10 not described above are conventional components that are well known in the art. Since these structures and devices are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the vehicle door assembly. Accordingly, these terms, as utilized to describe the present invention should be interpreted relative to a vehicle equipped with the vehicle door assembly.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A vehicle door assembly, comprising:
a vehicle body structure defining an opening;
a window movably connected to the vehicle body structure, the window being configured to move between a closed position at least partially closing the opening and an open position exposing the opening such that the window is at least partially disposed between a body member of the vehicle body structure and a trim element of the vehicle body structure; and
a movement mechanism having a movable member and a glass attachment structure attached to the movable member for pivotal movement with respect thereto, the movement mechanism being installed between the trim element and the body member and being configured to move the movable member and the window between the closed position and the open position.

2. The vehicle door assembly according to claim 1, wherein
the trim element is a headliner and the body member is a roof panel.

3. The vehicle door assembly according to claim 1, wherein
the trim element is a door trim panel and the body member is a door panel of a door attached to the vehicle body structure for pivotal movement with respect thereto.

4. The vehicle door assembly according to claim 1, wherein
the window has a substantially curved shape as viewed from sides thereof.

5. The vehicle door assembly according to claim 4, wherein
the vehicle body structure includes guide members located at opposite sides of the opening such that the window travels along the guide members between the closed and open positions, the guide members defining a first travel path having a substantially curved shape corresponding to the curved shape of the window.

6. The vehicle door assembly according to claim 5, wherein
the movement mechanism includes a track member rigidly fixed to the body member, the track member defining a second travel path such that the movable member moves along the second travel path between the closed position and the open position.

7. The vehicle door assembly according to claim 6, wherein
the shape of the second travel path is different from the shape of the first travel path such that with the window in the closed position the movable member is a first distance away from an adjacent portion of the first travel path and with the window in the open position the movable member is a second distance away from an adjacent portion of the first travel path, the first distance being different from the second distance.

8. The vehicle door assembly according to claim 7, wherein
the glass attachment structure pivots relative to the movable member as the window is moved between the open position and the closed position.

9. The vehicle door assembly according to claim 6, wherein
the track member is positioned between the guide members.

10. The vehicle door assembly according to claim 1, wherein
the glass attachment structure includes a first element and a second member attached to opposite ends of the movable member via respective hinges.

11. The vehicle door assembly according to claim 10, wherein
the window has a substantially curved shape as viewed from upper and lower ends thereof.

12. The vehicle door assembly according to claim 11, wherein
the first member and the second member each have bent portions that accommodate the curved shape of the window.

13. The vehicle door assembly according to claim 1, wherein
the glass attachment structure pivots relative to the movable member as the window is moved between the open position and the closed position.

14. The vehicle door assembly according to claim 1, further comprising
a lower door movably connected to the vehicle body structure, the lower door being configured to move between an upper closed position and a lower open position such that with both the lower door and the window in their respective closed positions a lower end of the window contacts an upper end of the lower door.

15. The vehicle door assembly according to claim 14, wherein
the window and the lower door are independently movable.

16. The vehicle door assembly according to claim 1, wherein
the window has a compound arcuate shape having an arcuate shape as viewed along sides thereof and a further arcuate shape as viewed along upper and lower edges thereof.

17. The vehicle door assembly according to claim 1, wherein
an overall height of the vehicle body structure is not increased when the window is located in the open position relative to the window being in the closed position.
